(19) United States
(12) Patent Application Publication
(10) Pub. No.: US 2007/0216360 A1
(43) Pub. Date: Sep. 20, 2007

(54) Battery control system and method

(76) Inventor: Taiken Matsui, Shizuoka-ken (JP)

Correspondence Address: Ernest A. Beutler, 10 Rue Marseille, Newport Beach, CA, 92660-8016, US

(21) Appl. No.: 11/684,090

(22) Filed: Mar. 9, 2007

(30) Foreign Application Priority Data
Mar. 15, 2006 (JP) 2006-70505
Mar. 15, 2006 (JP) 2006-70506
Mar. 15, 2006 (JP) 2006-70507

(51) Int. Cl. H02J 7/00

(52) U.S. Cl. 320/131

(57) ABSTRACT

A battery control for an electric motor powered device such as a golf car that includes a battery control and charging method that prolongs the life of the battery by controlling the method and rate of charging and discharging and preventing charging when it could be detrimental to the battery,.

### BACKGROUND OF THE INVENTION

This invention relates to a battery control system and method and more particularly to an arrangement and method for controlling both the discharge of the battery and in addition the charging of the battery to extend its life.

A first feature of the invention relates to a battery controller that controls such that if a battery is overcharged during charging and that the overcharge level of the battery varies with the usage thereof the amount of overcharging is controlled to extend the overall life of the battery can be extended.

One prior art method of overcharging a battery in such a way to extend its life is disclosed in Japanese Published Application JP-A-2001-160422. In this method, a battery such as a lead-acid battery, is overcharged regularly, for every predetermined number of charge and discharge cycles. Advantageously, with this configuration, the useful life of the battery can be prolonged.

The problem with such a system and method is that to obtain desired battery capacity, some types of batteries are desired to be overcharged during each charging process. One advantage of overcharging the battery is that the electrodes will be activated, so that deposition of a lead-sulfate compound on the electrodes is limited. That is, sulfation is prevented. Another advantage is that since the electrolyte in the battery is stirred, the lower portion of the electrolyte is prevented from having a high density. That is, stratification of the electrolyte is prevented. Thus, overcharging the battery as described above will provide desired battery capacity.

However and unfortunately, to many times of overcharging may accelerate deterioration of the electrodes and electrolyte, resulting in a significant decrease in useful life of the battery. Therefore and in view of the foregoing problem, it is, therefore, an object of the present invention to provide a battery controller that controls such that a battery is overcharged during charging to provide desired battery capacity and to prolong the useful life of the battery.

The present invention relates to a battery charge controller and a battery charge and discharge controller in which if a battery has been determined to have a failure, such as over discharge, one of the various charge modes stored in advance is selected in response to the failure to charge the battery using such mode.

Another problem attendant with prior art battery control and charging systems deals with an arrangement where a battery charge controller determines regularly whether or not a battery, which is a lead-acid battery, used as an emergency power source, has a failure. If no failure has been determined, the battery is charged and maintained at a desired charge level. As a result, the battery is available at any time in case of an emergency. If a failure has been determined, the charging is stopped.

Such a prior art system is disclosed in Published Japanese Application JP-A-Hei 5-236662. However such a system and method also has a problem. That is, there are many kinds of battery failures. Therefore, if the charging is stopped every time a battery failure has been determined, the availability of the battery may unnecessarily decrease.

Therefore it is another object of the present invention to provide a battery charge controller that enables charging a battery depending on a determined battery failure, so that the availability of the battery is enhanced.

The battery to be charged and/or discharged may be used in an electric powered driving apparatus for a vehicle is disclosed in Japanese Published application JP-A-2004-22152 As disclosed therein, the driving apparatus has an electric motor for driving a vehicle, powered by a battery such as a lead-acid battery that is charged by an external charger, while discharging electricity to the electric motor, and a motor controller for controlling the amount of discharging electricity from the battery to the electric motor in response to driver's operation. When the driver operates an operation unit, such as accelerator pedal, to drive a vehicle, the motor controller automatically determines the amount of discharging electricity from the battery to the electric motor in response to the displacement of the operation unit, so that the vehicle is accelerated or decelerated. Thus, the vehicle can be driven at a speed as the driver desires.

However, when the amount of discharge from the battery has increased after long hours of driving, in other words, when the amount of accumulated electricity has decreased, the vehicle need be stopped to charge the battery using the external charger until fully charged. Of course it is preferred that the battery is charged as quickly as possible. To achieve this, a conceivable approach is to increase an electric current from the charger, thereby charging the battery for a reduced period of time.

With such an approach, in the case where a large amount of electricity has been discharged from the battery, and there remains only a small amount of accumulated electricity, the battery is quickly charged for a short time of period by increasing the electric current.

The problem with this is even when the electric current is increased, excessive overcharging is avoided due to properties of the battery, and therefore, the battery is prevented from generating heat. However, in the case of a small amount of electricity which has been discharged from the battery, that is, a large amount of accumulated electricity, when the electric current is increased as described, excessive overcharging occurs easily due to the properties of the battery. Under such condition, the battery generates heat to a high temperature. This causes a reduction in a service life of the battery sooner than expected.

A conceivable approach to this problem would be to provide a battery control apparatus designed to detect the amount of electricity accumulated in the battery, determine a magnitude of the electric current automatically in response to the detected amount of electricity accumulated, and charge the battery with the electric current. However, adding such battery control apparatus results in an increase in number of parts required for the driving apparatus for a vehicle. This causes another problem of complicated configuration.

Thus another object of the present invention is to charge a battery quickly, while improving a service life of the battery with a simple configuration, when the battery is used as a power source of an electric motor for driving a vehicle.

### SUMMARY OF THE INVENTION

A first feature of this invention is adapted to be embodied in a battery control system comprising battery for powering an electric motor, a charger for selectively charging the battery, the charger being provided with at least two different charging modes, a sensor for monitoring battery condition during its life, and a control for determining the desired charging mode depending on the battery condition sensed by the sensor.

Another feature of the invention includes that of the preceding paragraph and the sensor senses at least one of history of battery discharge, previous overcharge conditions of the battery by the charger and a failure of the battery.

Yet another feature of the invention is adapted to be embodied in a battery control method wherein the charging of the battery powering an electric motor employing a charger for selectively charging the battery. The method comprises providing the charger with at least two different charging modes. And monitoring the battery condition during its life, and a determining the desired charging mode depending on the monitored battery condition.

Still another feature of the invention includes that of the preceding paragraph the condition of the battery and the condition sensed comprises at least one of history of battery discharge, previous overcharge conditions of the battery by the charger and a failure of the battery.

### BRIEF DESCRIPTION OF THE DRAWINGS

FIG. 1 is a partially schematic block diagram of an electric motor powered vehicle embodying the invention.

FIG. 2 is a diagram of the control routine in accordance with a feature of the invention.

FIG. 3 is a graphical view showing charge current and battery terminal voltage during a charging cycle in accordance with a feature of the invention.

FIG. 4 is a graphical view showing the battery terminal voltage during vehicle running conditions in accordance with another feature of the invention.

### DETAILED DESCRIPTION

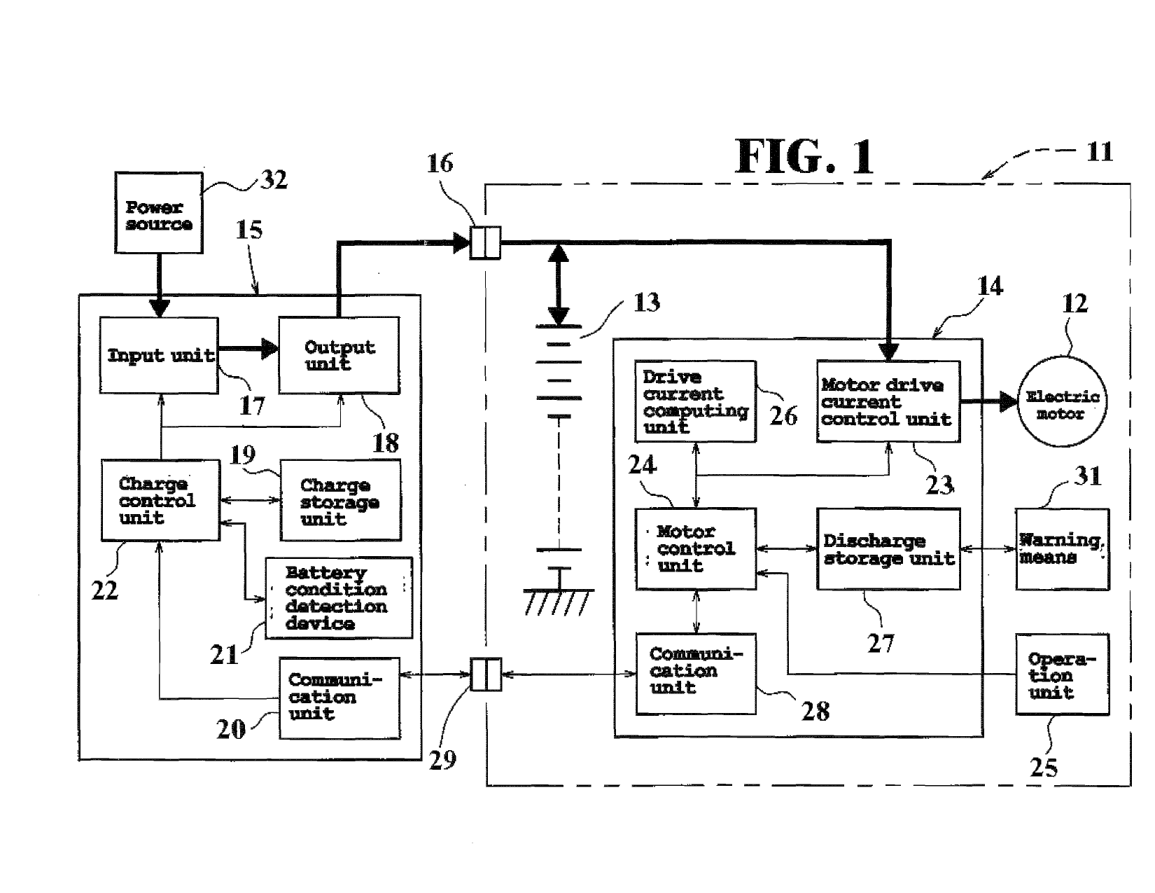

Referring now in detail to the drawings and initially to FIG. 1, although the invention is capable of use in many applications, by way of example it is illustrated for use in an electric driving apparatus, indicated generally at 11 is used on a vehicle, such as a golf cart operated on a golf course.

The driving apparatus 11 includes an electric motor 12 for driving the vehicle, a battery 13, and a motor controller 14. The electric motor 12 is carried on a vehicle body (not shown) and operatively connected to a drive wheel via a transmission (neither of which is shown, but may be of any desired type.

The battery 13 is a rechargeable lead-acid battery to which electricity can be supplied when being selectively connected to an external charger 15 via a coupling 16. Alternatively and if desired, the charger 15 may also be carried by the vehicle body. The motor controller 14 controls discharge (supply of electricity) from the battery 13 to the electric motor 12 in response to a driver's control or demands.

The charger 15 includes an input unit 17, an output unit 18, a charge storage unit 19, a battery condition detection device 21, a charge control unit 22, and a communication unit 20. The input unit 17 receives AC from a commercial power source 9 (100 VAC, 50/60 Hz) provided, such as in a charge stand and steps down the voltage. The output unit 18 converts the AC outputted from the input unit 17 into DC and then outputs the DC to the battery 13. The charge storage unit 19 has stored therein various charge modes selectively used for charging. The battery condition detection device 21 detects and identifies a failure of the battery 13. The charge control unit 22 selects one of the charge modes from the various charge modes stored in the charge storage unit 19 and then charges the battery 13 using such mode. The charge control unit 22 also stores an accumulated charge amount. A communication unit 20 transmits/receives a communication signal to and from the motor controller 14, which will be described in greater detail below.

The charge modes stored in the charge storage unit 19 are stored as maps. Of these charge modes, a “first mode” is used when the failure of the battery 13 has been identified as shortage of the electrolyte, so that charging is stopped. A “second mode” is used when the detected failure of the battery 13 has been identified as over discharge, so that the battery 13 is charged at a constant relatively small electric current.

The motor controller 14 includes a motor drive current control unit 23, a motor control unit 24, and a drive current computing unit 26. The motor drive current control unit 23 controls electric current to be supplied from the battery 13 to the electric motor 12, i.e., electric current to be delivered from the battery 13 to the electric motor 12. The motor control unit 24 detects the amount of operation of an operation unit 3 1, such as an acceleration pedal, to be operated by the driver and then outputs the detection signal. The drive current computing unit 26 computes electric current to be released from the battery 13 to the electric motor 12 based on the detection signal outputted from the motor control unit 24 and then causes the motor drive current control unit 23 to execute an intended control.

The motor controller 14 also includes a discharge storage unit 27 and a communication unit 28. The discharge storage unit 27 stores a most recent accumulated amount of discharge to the electric motor 12 before charging, and a current accumulated amount of electricity in the battery 13 based on the accumulated discharge amount. The communication unit 28 is selectively connectable to the communication unit 20 of the charger 15 via a coupling 29 to transmit/receive a communication signal to and from the communication unit 20. A warning means 31 is provided for issuing a warning based on a signal outputted from the discharge storage unit 27. This warning means 31 can be either or both of a visual device and an audible device.

When driving the vehicle, the driver manipulates the couplings 16, 29 to disconnect the charger 15 from the battery 13 and the motor controller 14. When the driver operates the operation unit 31, the operation amount is detected by the motor control unit 24 of the motor controller 14. Based on the detection signal from the motor control unit 24, the drive current computing unit 26 computes electric current to be released from the battery 13 to the electric motor 12.

Based on the computation by the drive current computing unit 26, the motor drive current control unit 23 controls automatically the amount of electric current to be released from the battery 13 to the electric motor 12. In other words, in response to a driver's operation of the operation unit 31, a certain amount of electricity is released automatically from the battery 13 to the electric motor 12. As a result, the electric motor 12 will output a driving force as the driver desires, thereby enabling acceleration or deceleration of the vehicle. Thus, the vehicle can be driven at a speed as the driver desires.

On this occasion, an accumulated amount of discharge from the battery 13 to the electric motor 12 is stored in the discharge storage unit 27. When the accumulated amount of discharge from the battery 13 has increased, i.e., when the accumulated amount of electricity has decreased, for example after long hours of operation, the vehicle is stopped to charge the battery 13. To charge the battery 13, the driver first manipulates the couplings 16, 29 to connect the charger 15 to the battery 13 and the motor controller 14. As a result, electric current will be supplied from an external power source 32 through the input unit 17, the output unit 18, and the coupling 16 to the battery 13, so that the battery 13 will be charged. At this time, the accumulated charge amount is stored into the charge control unit 22.

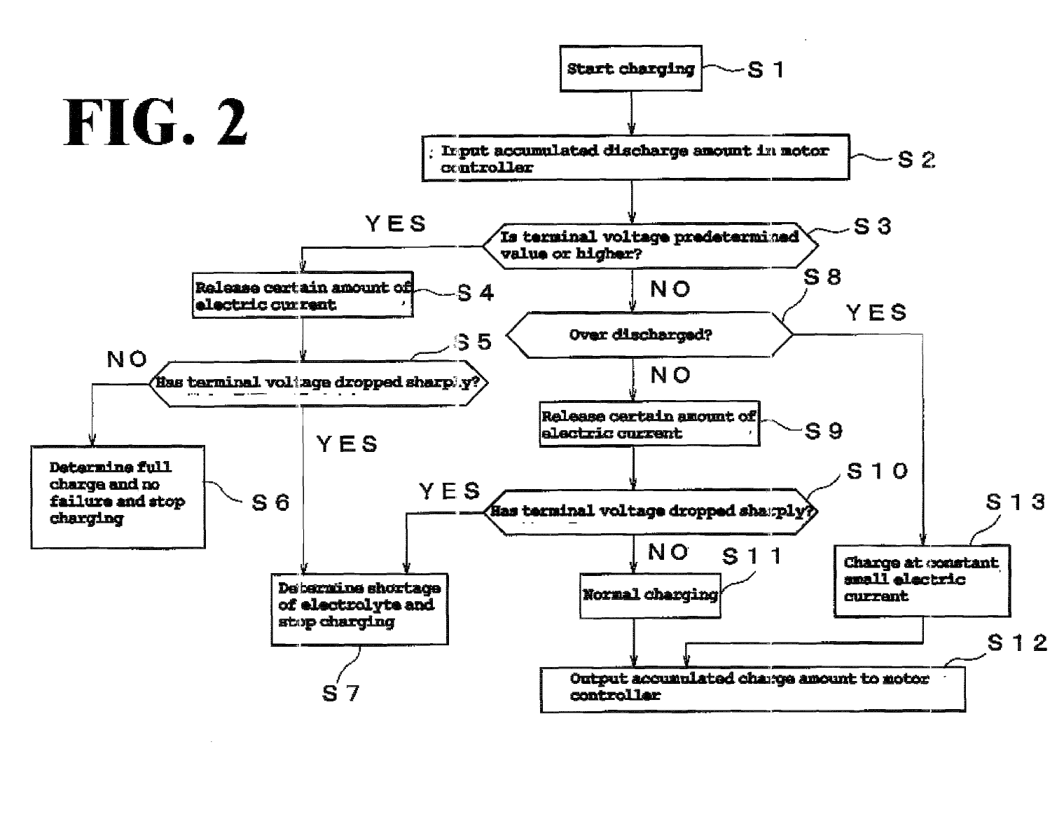

The control routine of the system thus far described will now be described by primary reference to FIG. 2. When charging is started at the step SI the most recent accumulated discharge amount stored in the discharge storage unit 27 of the motor controller 14 is inputted to the charge control unit 22 via the motor control unit 24, the communication unit 28, the coupling 29, and the communication unit 20 at the step S2.

Then, at the step S3, the charge control unit 22 determines whether or not the terminal voltage V of the battery 13 is a predetermined value or higher.

If the determination at the step S3 is that the terminal voltage V of the battery 13 is a predetermined value or higher, based on a control by the battery condition detection device 21, the motor control unit 24 causes the motor drive current control unit 23 to release a certain amount of electric current from the battery 13 to the electric motor 12, lighting equipment, and any other electrical devices of the golf cart at the step S4. The released electric current will be consumed by the electric motor 12, etc. At this time, due to the structure of the electric motor 12, the electric motor 12 is prevented from being driven to start the vehicle.

When the battery is discharged at the step S4, it is determined at the step S5 whether or not the terminal voltage V of the battery 13 drops sharply. If the terminal voltage V of the battery 13 has dropped correspondingly to the discharge and no sharp drop is determined in S5, the battery 1.3 is determined to be fully charged and have no failure, so that the charging is stopped at the step S6.

However, if a sharp drop of the terminal voltage V of the battery 13 is determined at the step S5, the battery condition detection device 21 determines a failure of the battery 13 and identifies it as shortage of the electrolyte. Then, the “first mode” is selected from the charge modes stored in the charge storage unit 19, so that charging is stopped at the step S7. On this occasion, the user will be warned to supply electrolyte to the battery 13 and manually to start charging again at the step S1.

If, however, the determination made at the step S3 is that the terminal voltage V of the battery 13 is not the predetermined value or higher, it is determined whether or not the battery 13 is over discharged at the step S8. Over discharge will occur, for example, when the vehicle is left unattended for a long period of time. The determination on over discharge is made by comparing the preceding accumulated charge amount stored in the charge storage unit 19 of the charger 15 against the most recent accumulated discharge amount stored in the discharge storage unit 27 of the motor controller 14 based on self-discharge of the battery 13 during the long unattended period.

If the determination made at the step S8 is that the battery is not over discharged, a certain amount of electric current is released from the battery 13 at the step S9 the same as in S4. When the battery is discharged in S9, it is determined whether or not the terminal voltage V of the battery 13 drops sharply at the step S10 the same as was done at the step S5.

If the determination at the step S10 is that the terminal voltage V of the battery 13 has not dropped sharply, the battery 13 undergoes normal charging at the step S11, which will be described in greater detail shortly. The accumulated charge amount after the normal charging is stored in the charge storage unit 19 of the charger 15 to be outputted to the motor control unit 24 of the motor controller 14 at the step S12.

If a sharp drop of the terminal voltage V of the battery 13 has been determined at the S10, this condition is the same as “YES” at the step S5, so that the step S7 is executed. That is, the user will be warned to supply electrolyte to the battery 13 and manually to start charging again at the step S1

If, however, the determination at the step S8 based on the comparison of the preceding accumulated charge amount stored in the charge storage unit 19 of the charger 15 against the most recent accumulated discharge amount before charging stored in the discharge storage unit 27 of the motor controller 14 is that the accumulated discharge amount is excessively large, the battery condition detection device 21l determines a failure of the battery 13 and identifies it as over discharge. Then, the “second mode” is selected from the charge modes stored in the charge storage unit 19, so that the battery 13 is charged at a constant relatively small electric current (4A) for a long period of time at the step S13. The accumulated charge amount after the charging is stored in the charge storage unit 19 of the charger 15 to be outputted to the motor control unit 24 of the motor controller 14 then at the step S12.

Thus, with the configuration described, the charge storage unit 19 having stored therein the various charge modes used for charging the battery 13, and the battery condition detection device 21 for detecting and identifying a failure of the battery 13 are provided. In response to the failure identified by the battery condition detection device 21, one of the charge modes stored in the charge storage unit 19 is selected to charge the battery using such mode.

As a result of this methodology, even if the battery condition detection device 21 has determined a failure of the battery 13, the battery 13 can be charged through the charge storage unit 19 in a way that depends on the type of failure. Thus, compared to a conventional where charging is stopped every time a failure of the battery 13 has been determined, the availability of the battery 13 is enhanced.

As has been described, a certain amount of electric current is released from the battery 13 to identify the failure. As a result, identification of a failure of the battery 13 can be implemented easily with the simple configuration. Thus, the enhanced use of the battery 13 is achieved easily with the simple configuration.

As also described, if the battery condition detection device 21 has determined no failure of the battery 13, the battery 13 undergoes normal charging. If an over discharge state of the battery 13 has been determined, the battery is charged at a constant relatively small electric current. If shortage of the electrolyte of the battery 13 has been determined, charging is stopped. As a result, specifically an over discharge state of the battery 13 is avoided from being determined to be a failure, so that charging will not be stopped. Thus, the availability of the battery 13 is enhanced.

As also described, an over discharged battery 13 is charged at a constant relatively small electric current. As a result, compared to charging at a relatively large electric current, an excessive overcharge is prevented, which is increases the useful life of the battery 13.

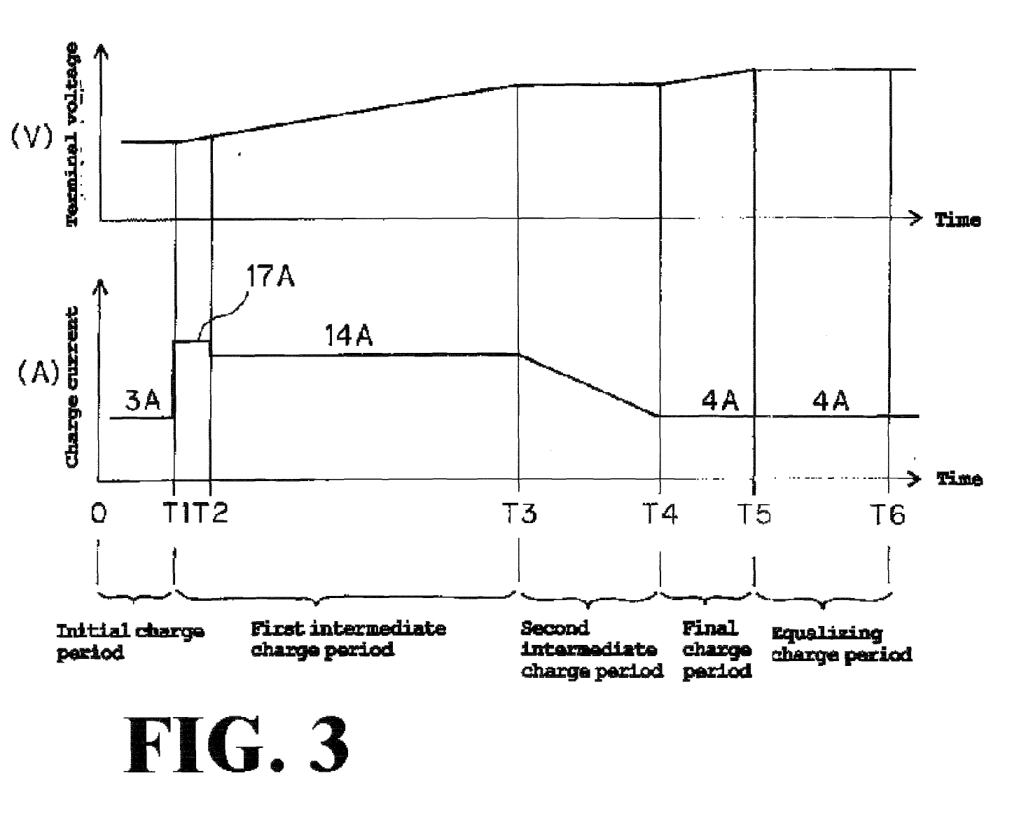

The method of charging the battery 13, will now be described by reference to FIG. 3. This method is called multistage charging and is used for normal charging. In an initial charge period (0 to T1), an electric current of 3 A (ampere) is applied. The charger 15 and the motor controller 14 determine whether or not the battery 13 has a failure. If there is no failure, the charging process will be continued as follows.

In a first intermediate charge period (T1 to T2) a charging current of 17 A is applied following the initial charge period (0 to T1). Then a substantially constant relatively large electric current of 14A is applied for a duration (T2 to T3) of about 14 hours.

Then in a second intermediate charge period (T3 to T4) following the first intermediate charge period, the amount of electric current is decreased linearly from 14 A to 4 A over a duration of about 4.5 hours. Then in a final charge period (T4 to T5) following the second intermediate charge period, a constant relatively small electric current of 4 A is applied. This is followed in a subsequent equalizing charge period (T5 to T6), where a constant relatively small electric current of 4 A is continued to be applied.

As a result and as shown by the upper curve of this figure, the terminal voltage V of the battery 13 will rise to bring the battery 13 to an overcharge state in the final charge period. More specifically, when a most recent accumulated discharge amount (AH) detected and stored into the discharge storage unit 27 before charging is compared against an accumulated charge amount (AH) detected and stored into the charge storage unit 19 after overcharging, the rate of the accumulated charge amount to the accumulated discharge amount of larger than 1.0 is expected to be determined.

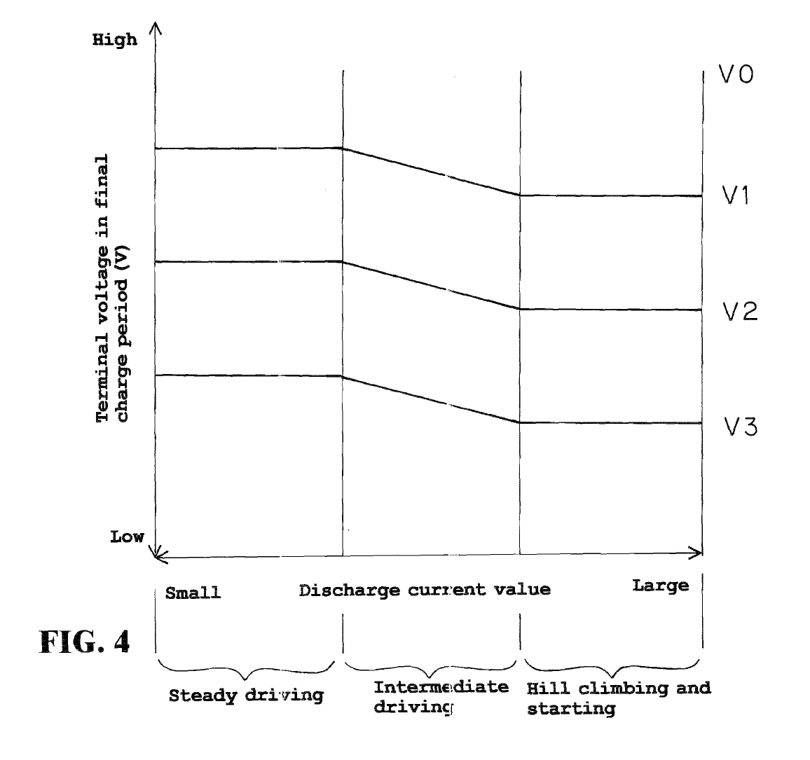

The condition of the battery during successive operations of the golf cart is illustrated in FIG. 4. This shows that when the vehicle is in operation, the amount of electric current released from the battery 13 is generally larger during intermediate driving than during steady driving and larger during hill climbing or starting than during intermediate driving. The terminal voltage of the battery during discharging significantly decreases correspondingly.

As seen from this view, during hill climbing or starting, a minimum discharge voltage V1, V2, V3 of the battery 13 is stored into the discharge storage unit 27, based on the terminal voltage V in the final charge period. Specifically, a first terminal voltage V in the final charge period based on the normal charging in S11 is V0 (65 V)>first V≧V1 (62 V). In this case, the minimum discharge voltage is V1. In the normal charging, the terminal voltage V may be a second terminal voltage V slightly lower than the first terminal voltage V. In this case, the second terminal voltage V is V1 (62 V)>second V≧V2 (60 V). The minimum discharge voltage is V2. When the battery is charged at a relatively small electric current in S13, a third terminal voltage V in the final charge period is V2 (60 V)>third V≧V3. In this case, the minimum discharge voltage is V3.

When the terminal voltage V has dropped to any of the minimum discharge voltages V1, V2, and V3 during discharge from the battery 13, the warning means 31 issues a warning.

As has been noted, the warning may be an audible sound or visible light. Alternatively, it may be a signal indicating an automatic stop of vehicle operation or battery discharge, or a signal prompting the driver to charge the battery. During steady driving or intermediate driving, the minimum discharge voltages V1, V2, and V3 are set slightly larger than during hill climbing or starting.

With the configuration described above, when the terminal voltage V drops and then a warning is issued during discharge from the battery 13, if the driver stops the discharge for example, according to the warning, a relatively large accumulated discharge amount can be obtained for the longest possible period even if the terminal voltage of the battery 13 varies in the final charge period. Also, the depth of discharge is prevented from becoming excessively large. As a result, the useful life of the battery 13 can be prolonged.

From the foregoing description it should be readily apparent that the described charging and discharging arrangement is very useful in prolonging the battery life in a number of ways. Also ss has been described, the battery 13 is a lead-acid battery. Generally, the lead-acid battery holds a relatively large amount of electricity and is designed for general purpose use. The lead-acid battery is thus used in accordance with the described embodiment. However those skilled in the art will readily understand that that aforedescribed construction and methodology can be subject to many variations without departing from the spirit and scope of the invention, as defined by the appended claims. As one example even though a lead-acid battery can satisfy the need for large energy for the vehicle and low cost. It should also be understood that the battery employed is not limited to the lead-acid battery but may be a NiCd battery or a silver oxide-zinc battery. Furthermore the vehicle powered by the battery is not limited to one driven in a restricted area such as a golf course, but may be a commonly available vehicle driven on public roads or, for that matter, the battery controlled may be used for a variety of other purposes.. Furthermore, the charge storage unit 19 and the discharge storage unit 27 may be formed together into a controller that is separate from the charger 15 and the motor controller 14. Further, the minimum discharge voltages may be slightly lower than the minimum discharge voltages V1, V2, and V3 described above. In addition not all of the several disclosed control methods need be used together in a single application.

1. A battery control system comprising a battery for powering an electric motor, a charger for selectively charging said battery, said charger being provided with at least two different charging modes, a sensor for monitoring battery condition during its life, and a control for determining the desired charging mode depending on the battery condition sensed by said sensor.

2. A battery control system as set forth in claim 1 wherein the sensor senses at least one of history of battery discharge, previous overcharge conditions of the battery by the charger and a failure of the battery.

3. A battery control system as set forth in claim 2 wherein the electric motor powers a vehicle and further including a motor controller for controlling the amount of discharging electricity from the battery to the electric motor in response to a driver's operation.

4. A battery control system as set forth in claim 3 wherein the charger is external of the vehicle and wherein the electric powered driving apparatus comprises a charge storage unit for storing various charge modes used for charging the battery, and a communication unit for inputting to the charge storage unit latest history data on discharging electricity from the battery immediately before charging the battery, and in order to charge the battery, one of the various charge modes stored in the charge storage unit is selected corresponding to the history data on discharging electricity from the battery, which is inputted to the charge storage unit through the communication unit, so that the battery is charged in the selected mode.

5. A battery control system as set forth in claim 4 wherein the battery comprises a lead acid battery.

6. A battery control system as set forth in claim 2 wherein a most recent accumulated discharge amount is detected before charging, an accumulated charge amount is detected after a battery is overcharged during the charging, and an overcharge rate determined by comparing the accumulated charge amount against the accumulated discharge amount is decreased with the usage of the battery to control overcharging.

7. A battery control system as set forth in claim 6, wherein the overcharge rate is set to 1.2 to 1.3 at an early stage of the usage of the battery, and to 1.05 to 1.15 at a final stage.

8. A battery control system as set forth in claim 7 wherein a warning is issued when terminal voltage of a battery has dropped to a predetermined value due to discharge from the battery, and wherein the predetermined value is decreased with the usage of the battery.

9. A battery control system as set forth in claim 2 wherein a failure of the battery, is sensed.

10. A battery control system as set forth in claim 9 wherein the control causes the battery to release a certain amount of electric current to identify the failure.

11. A battery control system as set forth in claim 10 wherein if no failure of the battery is sensed normal charging is applied to the battery; if an over discharge state of the battery has been determined, the battery is charged at a constant relatively small electric current; and if shortage of electrolyte of the battery has been determined, charging is stopped.

12. A method for controlling the charging of a battery powering an electric motor employing a charger for selectively charging said battery, said method comprising providing the charger with at least two different charging modes, monitoring battery condition during its life, and a determining the desired charging mode depending on the monitored battery condition.

13. A method as set forth in claim 12 wherein the condition of the battery sensed comprises at least one of history of battery discharge, previous overcharge conditions of the battery by the charger and a failure of the battery.

14. A method as set forth in claim 13 wherein a most recent accumulated discharge amount is detected before charging, an accumulated charge amount is detected after a battery is overcharged during the charging, and an overcharge rate determined by comparing the accumulated charge amount against the accumulated discharge amount is decreased with the usage of the battery to control overcharging.

15. A method as set forth in claim 14, wherein the overcharge rate is set to 1.2 to 1.3 at an early stage of the usage of the battery, and to 1.05 to 1.15 at a final stage.

16. A method as set forth in claim 15 wherein a warning is issued when terminal voltage of a battery has dropped to a predetermined value due to discharge from the battery and wherein the predetermined value is decreased with the usage of the battery.

17. A method as set forth in claim 13 wherein a failure of the battery, is sensed.

18. A method as set forth in claim 17 wherein the battery is caused to release a certain amount of electric current to identify the failure.

19. A method as set forth in claim 18 wherein if no failure of the battery is sensed normal charging is applied to the battery; if an over discharge state of the battery has been determined, the battery is charged at a constant relatively small electric current; and if shortage of electrolyte of the battery has been determined, charging is stopped.
